(19) United States
(12) Patent Application Publication
(10) Pub. No.: US 2022/0078332 A1
(43) Pub. Date: Mar. 10, 2022

(54) INFORMATION PROCESSING APPARATUS, INFORMATION PROCESSING SYSTEM, INFORMATION PROCESSING METHOD, AND NON-TRANSITORY RECORDING MEDIUM

(71) Applicant: Kohichi HIRAI, Kanagawa (JP)

(72) Inventor: Kohichi HIRAI, Kanagawa (JP)

(73) Assignee: Ricoh Company, Ltd.

(21) Appl. No.: 17/392,280

(22) Filed: Aug. 3, 2021

(30) Foreign Application Priority Data
Sep. 10, 2020 (JP) 2020-151975

(51) Int. Cl. H04N 5/232; G06F 9/54; H04L 29/08

(52) U.S. Cl. CPC H04N 5/23206; H04L 67/025; G06F 9/547; G06F 9/542

(57) ABSTRACT

An information processing apparatus includes a memory and first circuitry. The memory stores event identification information identifying an event. The first circuitry registers terminal identification information in association with the event identification information stored in the memory. The terminal identification information identifies an information processing terminal to be used in the event, and is received during a time from receipt of a registration start instruction to start registration of the information processing terminal to receipt of a registration end instruction to end the registration of the information processing terminal.

### CROSS-REFERENCE TO RELATED APPLICATION

This patent application is based on and claims priority pursuant to 35 U.S.C. § 119(a) to Japanese Patent Application No. 2020-151975 filed on Sep. 10, 2020 in the Japan Patent Office, the entire disclosure of which is hereby incorporated by reference herein.

### BACKGROUND

### Technical Field

The present invention relates to an information processing apparatus, an information processing system, an information processing method, and a non-transitory recording medium.

### Description of the Related Art

There has been a camera control system for remote-controlling cameras installed in a tourist site or theme park as a travel destination. This system allows a user previously registered as a member having access to the system to remote-control a selected one of the cameras to capture images with the camera and use the captured images later after returning from travel.

With this camera control system, however, it is difficult for the user to manage, for each event, an information processing terminal to be remote-controlled.

### SUMMARY

In one embodiment of this invention, there is provided an improved information processing apparatus that includes, for example, a memory and first circuitry. The memory stores event identification information identifying an event. The first circuitry registers terminal identification information in association with the event identification information stored in the memory. The terminal identification information identifies an information processing terminal to be used in the event, and is received during a time from receipt of a registration start instruction to start registration of the information processing terminal to receipt of a registration end instruction to end the registration of the information processing terminal.

In one embodiment of this invention, there is provided an improved information processing system that includes, for example, the above-described information processing apparatus and an information processing terminal including second circuitry. The second circuitry of the information processing terminal acquires connection information for connecting to the information processing apparatus, and transmits terminal identification information identifying the information processing terminal to the information processing apparatus based on the acquired connection information.

In one embodiment of this invention, there is provided an improved information processing system that includes, for example, the above-described information processing apparatus, an information processing terminal, and a communication terminal including third circuitry. The third circuitry of the communication terminal acquires terminal identification information identifying the information processing terminal, transmits the acquired terminal identification information to the information processing apparatus, and causes a display to display a screen to receive a registration start instruction to start registration of the terminal identification information and a registration end instruction to end the registration of the terminal identification information. The information processing apparatus receives the terminal identification information from the communication terminal.

In one embodiment of this invention, there is provided an improved information processing method that includes, for example, with an information processing apparatus, storing event identification information identifying an event in a memory, and with the information processing apparatus, registering terminal identification information in association with the event identification information stored in the memory. The terminal identification information identifies an information processing terminal to be used in the event, and is received during a time from receipt of a registration start instruction to start registration of the information processing terminal to receipt of a registration end instruction to end the registration of the information processing terminal.

In one embodiment of this invention, there is provided a non-transitory recording medium storing a plurality of instructions which, when executed by one or more processors, cause the processors to perform the above-described information processing method.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating a configuration example of an information processing system of an embodiment of the present invention;

FIG. 2 is a diagram illustrating an arrangement example of the information processing system of the embodiment;

FIG. 3 is a block diagram illustrating an example of the hardware configuration of a web server included in the information processing system of the embodiment;

FIG. 4 is a block diagram illustrating an example of the hardware configuration of a smartphone included in the information processing system of the embodiment;

FIG. 5 is a block diagram illustrating an example of the hardware configuration of a spherical imaging device included in the information processing system of the embodiment;

FIG. 6 is a block diagram illustrating an example of the functional configuration of the information processing system of the embodiment;

FIG. 7 is a table illustrating an example of lecture information of the embodiment;

FIG. 8 is a table illustrating an example of registration status of the spherical imaging device of the embodiment;

FIG. 9 is a table illustrating an example of status information of the spherical imaging device of the embodiment;

FIG. 10 is a sequence diagram illustrating a registration process of the spherical imaging device of the embodiment;

FIG. 11 is a sequence diagram illustrating an image capturing process of the spherical imaging device of the embodiment;

FIG. 12 is a diagram illustrating an example of a screen displayed on the smartphone of the embodiment; and

FIG. 13 is a diagram illustrating another example of the screen displayed on the smartphone of the embodiment.

The accompanying drawings are intended to depict embodiments of the present invention and should not be interpreted to limit the scope thereof The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. In the drawings illustrating embodiments of the present invention, members or components having the same function or shape will be denoted with the same reference numerals to avoid redundant description.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

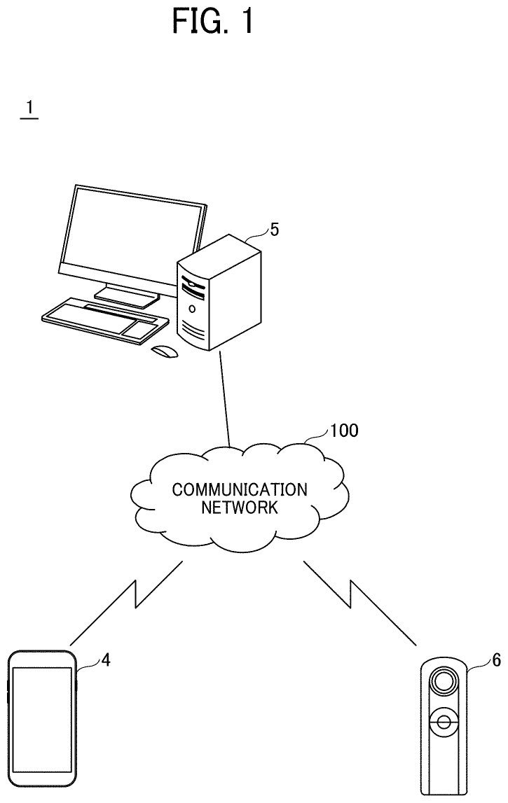

FIG. 1 is a diagram illustrating a configuration example of an information processing system of an embodiment of the present invention. As illustrated in FIG. 1, an information processing system 1 includes a world wide web (web) server 5, a smartphone 4, and a spherical imaging device 6, each of which includes a wireless or wired communication device. The web server 5, the smartphone 4, and the spherical imaging device 6 are communicably connected to each other via a communication network 100 such as a local area network (LAN) or the Internet.

The web server 5 is a server computer that provides a service of allowing a web browser as client software to display the hypertext markup language (HTML) and objects such as images in accordance with the hypertext transfer protocol (HTTP). The web server 5 is an example of an information processing apparatus.

The information processing apparatus is not limited to the web server, and may be a personal computer (PC), for example, which is communicable with the other devices via a network. It is preferable, however, to use the web server as the information processing apparatus, since the web server enables the HTML and the objects such as images to be displayed in parallel on the respective screens of multiple terminals connected to the communication network 100.

The information processing system 1 is not necessarily connected to a single information processing apparatus, and may be connected to a plurality of information processing apparatuses. Further, later-described functions of the information processing apparatus may be implemented by processing of a single information processing apparatus or by distributed processing using multiple information processing apparatuses.

The smartphone 4 is a terminal communicably connected to the web server 5. The smartphone 4 is an example of a communication terminal.

The smartphone 4 includes a screen serving as an operation unit for issuing an instruction to start image capturing and an instruction to end the image capturing.

The communication terminal is not limited to the smartphone, and may be a tablet, PC, or mobile phone, for example. Further, the information processing system 1 is not necessarily connected to a single communication terminal, and may be connected to a plurality of communication terminals.

The spherical imaging device 6 is capable of capturing images such as a still image and a streaming video image with a 360-degree field of view in up, down, right, and left directions. The spherical imaging device 6 is an example of an information processing terminal.

The information processing system 1 is not necessarily connected to a single information processing terminal, and may be connected to a plurality of information processing terminals. Further, the information processing terminal is not limited to the spherical imaging device, and may be any other imaging device capable of capturing a still or video image. It is preferable, however, to use the spherical imaging device as the information processing terminal, since the spherical imaging device is capable of capturing the still or video image with a wide field of view, obviating the need for multiple information processing terminals.

The information processing system 1 may also be connected to another component having a communication function, as well as the components illustrated in FIG. 1. Such a component may be a projector (PJ), interactive whiteboard (IWB) (i.e., electronic whiteboard capable of communicating with another device), output device for digital signage, head-up display (HUD), industrial machine, imaging device, sound collector, medical equipment, network home appliance, connected car, laptop PC, mobile phone, smartphone, tablet terminal, gaming system, personal digital assistant (PDA), digital camera, wearable PC, or desktop PC, for example.

In the information processing system 1 of the embodiment, a user of the smartphone 4 remote-controls the spherical imaging device 6 with the smartphone 4 to cause the spherical imaging device 6 to capture a desired image.

Further, in the information processing system 1, the smartphone 4 acquires from the web server 5 connection information to be referred to in the communication with the web server 5, and provides the acquired connection information to the spherical imaging device 6. The connection information includes the internet protocol (IP) address of the web server 5 and a lecture identifier (ID) for identifying a lecture, for example. The lecture ID as identification information for identifying the lecture is previously held in the web server 5. The lecture ID is an example of event identification information for identifying an event.

With the connection information acquired, the spherical imaging device 6 is able to communicate with the web server 5. The information processing system 1 thereby enables the remote control of the spherical imaging device 6 with the smartphone 4 via the web server 5.

More specifically, in the information processing system 1, the smartphone 4 acquires the connection information from the web server 5 and provides the spherical imaging device 6 with the connection information and identification information for identifying the smartphone 4. In the following description, the identification information for identifying the smartphone 4 may be described as the smartphone ID. The smartphone ID is an example of communication terminal identification information for identifying the communication terminal that communicates with the web server 5.

When communicating with the web server 5 based on the connection information, the spherical imaging device 6 transmits to the web server 5 the smartphone ID acquired from the smartphone 4 and identification information for identifying the spherical imaging device 6. In the following description, the identification information for identifying the spherical imaging device 6 may be described as the terminal ID. The terminal ID is an example of terminal identification information.

The web server 5 holds the smartphone ID and the terminal ID acquired from the spherical imaging device 6 in association with the lecture ID. Thereby, the smartphone 4 and the spherical imaging device 6 are associated with each other, enabling the remote control of the spherical imaging device 6 with the smartphone 4 via the web server 5.

In the following description, holding in the web server 5 information associating the smartphone 4 with the spherical imaging device 6 may be described as registering the spherical imaging device 6 in the web server 5.

As described above, in the information processing system 1 of the embodiment, simply providing the connection information of the web server 5 to the spherical imaging device 6 from the smartphone 4 enables the remote control of the spherical imaging device 6 with the smartphone 4 in a target lecture.

That is, according to the information processing system 1 of the embodiment, it is unnecessary to previously register in the web server 5 the spherical imaging device 6 to be remote-controlled. Consequently, the remote control of the spherical imaging device 6 with the smartphone 4 is facilitated, and the information processing terminal to be remote-controlled is manageable by event.

In the following description of the embodiment, a lecture support system for supporting an instructor to deliver a lecture to students in a classroom of an educational facility will be described as an example of the information processing system 1. In the embodiment, the images of the students in the lecture are captured in each of groups of the students in accordance with an instruction from the communication terminal used by the instructor. The instructor is thereby able to capture the images of the students in the respective groups via the communication terminal.

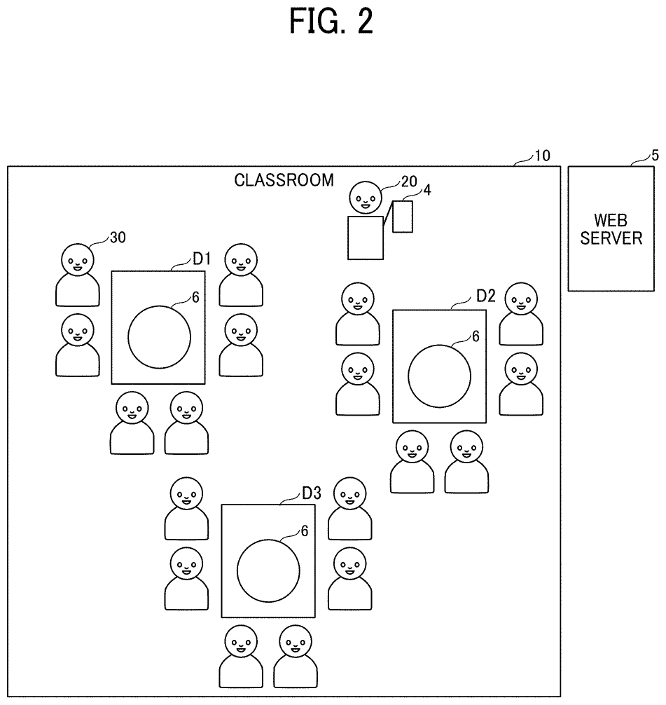

FIG. 2 is a diagram illustrating an arrangement example of the information processing system 1. FIG. 2 illustrates the information processing system 1 arranged in a classroom 10, in which an instructor 20 delivers a lecture to students 30 with the information processing system 1.

Herein, the web server 5 is disposed outside the classroom 10, but may be disposed inside the classroom 10. Further, in FIG. 2, the web server 5 is disposed outside and in the vicinity of the classroom 10, but may be disposed at a remote site distant from the classroom 10.

The instructor 20 holds the smartphone 4 such that the screen of the smartphone 4 is viewable to the instructor 20. The instructor 20, however, is not necessarily required to hold the smartphone 4, and may place the smartphone 4 on the surface of a desk, for example, such that the screen of the smartphone 4 is viewable to the instructor 20.

The students 30 are seated around desks D1, D2, and D3 arranged in the classroom 10. In the example of FIG. 2, the students 30 are divided into groups of six, with each six students being seated around one of desks D1 to D3.

The number of students forming each group is not limited to six, and may be less or more than six. Further, the number of students forming each group may be the same or different among the groups. Similarly, the number of groups is not limited to three, and may be less or more than three. Further, the desks D1 to D3 arranged in the classroom 10 are not limited to particular positions, and may be moved to change the positions thereof.

The spherical imaging device 6 is placed on each of the desks D1 to D3 to capture the image of six students forming the corresponding group.

The image captured by the spherical imaging device 6 is transmitted to the web server 5. It suffices if the image captured by the spherical imaging device 6 includes at least a part of the body of each of the six students. On each of the desks D1 to D3, the spherical imaging device 6 may be moved to change the position thereof.

With the spherical imaging device 6 provided to each of the groups, the information processing system 1 is capable of acquiring the image of the students included in the group.

An example of the hardware configuration of the web server 5 will be described.

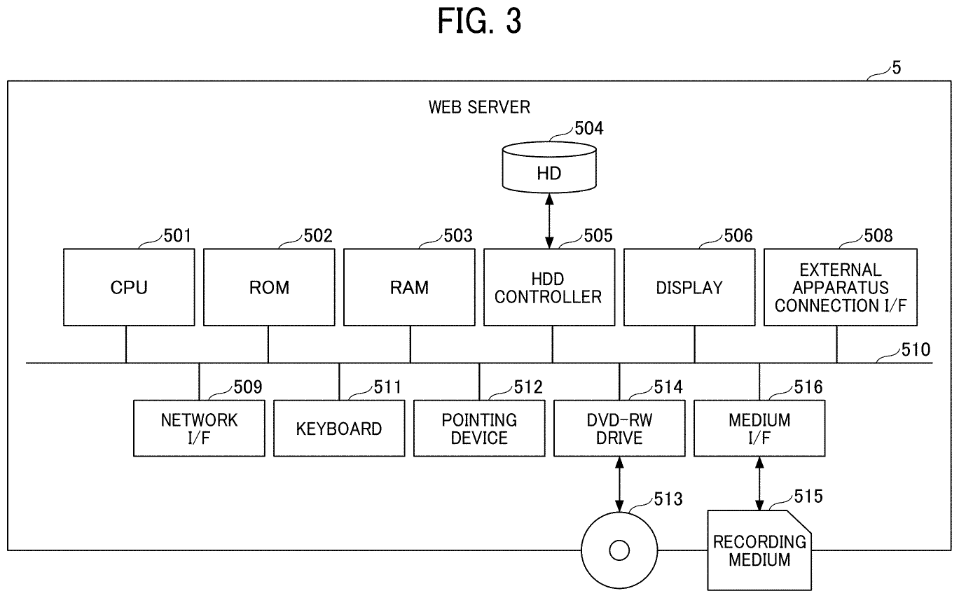

FIG. 3 is a block diagram illustrating an example of the hardware configuration of the web server 5. As illustrated in FIG. 3, the web server 5 is implemented by a computer, and includes a central processing unit (CPU) 501, a read only memory (ROM) 502, a random access memory (RAM) 503, a hard disk (HD) 504, a hard disk drive (HDD) controller 505, a display 506, an external apparatus connection interface (I/F) 508, a network I/F 509, a data bus 510, a keyboard 511, a pointing device 512, a digital versatile disk-rewritable (DVD-RW) drive 514, and a medium I/F 516.

The CPU 501 controls the overall operation of the web server 5. The ROM 502 stores a program used to drive the CPU 501, such as an initial program loader (IPL). The RAM 503 is used as a work area for the CPU 501. The HD 504 stores various data of programs, for example. The HDD controller 505 controls writing and reading of various data to and from the HD 504 under the control of the CPU 501. The display 506 displays various information such as a cursor, menus, windows, text, and images. The external apparatus connection I/F 508 is an interface for connecting the web server 5 to various external apparatuses. The external apparatuses in this case include a universal serial bus (USB) memory and a printer, for example. The network I/F 509 is an interface for performing data communication via the communication network 100. The data bus 510 includes an address bus and a data bus for electrically connecting the CPU 501 and the other components in FIG. 3 to each other.

The keyboard 511 is an input device including a plurality of keys for inputting text, numerical values, and various instructions, for example. The pointing device 512 is an input device used to select and execute various instructions, select a processing target, and move the cursor, for example. The DVD-RW drive 514 controls writing and reading of various data to and from a DVD-RW 513 as an example of a removable recording medium. The removable recording medium is not limited to the DVD-RW, and may be a DVD-recordable (DVD-R), for example. The medium I/F 516 controls writing (i.e., storage) and reading of data to and from a recording medium 515 such as a flash memory.

A hardware configuration of the smartphone 4 will be described.

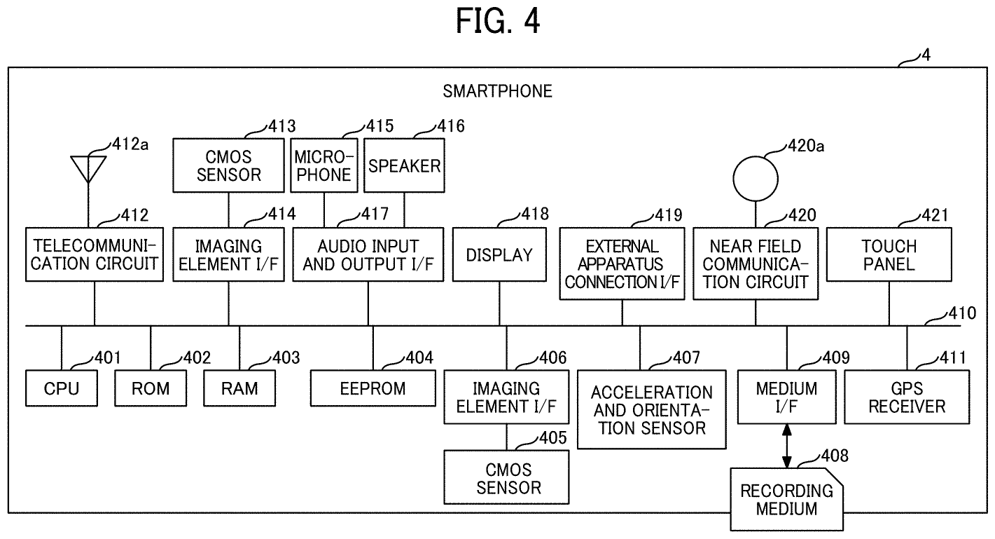

FIG. 4 is a block diagram illustrating an example of the hardware configuration of the smartphone 4. As illustrated in FIG. 4, the smartphone 4 includes a CPU 401, a ROM 402, a RAM 403, an electrically erasable programmable ROM (EEPROM) 404, a complementary metal oxide semiconductor (CMOS) sensor 405, an imaging element I/F 406, an acceleration and orientation sensor 407, a medium I/F 409, and a global positioning system (GPS) receiver 411.

The CPU 401 controls the overall operation of the smartphone 4. The ROM 402 stores programs for the CPU 401 and a program used to drive the CPU 401 such as the IPL. The RAM 403 is used as a work area for the CPU 401. The EEPROM 404 performs reading or writing of various data of a program for the smartphone 4, for example, under the control of the CPU 401. The CMOS sensor 405 is a built-in imaging device that captures the image of a subject (normally the image of the user) under the control of the CPU 401 to obtain image data. The CMOS sensor 405 may be replaced with an imaging device such as a charge coupled device (CCD) sensor, for example. The imaging element I/F 406 is a circuit that controls the driving of the CMOS sensor 405. The acceleration and orientation sensor 407 includes various sensors such as an electromagnetic compass that detects geomagnetism, a gyrocompass, and an acceleration sensor. The medium I/F 409 controls writing (i.e., storage) and reading of data to and from a recording medium 408 such as a flash memory. The GPS receiver 411 receives a GPS signal from a GPS satellite.

The smartphone 4 further includes a telecommunication circuit 412, an antenna 412a for the telecommunication circuit 412, a CMOS sensor 413, an imaging element I/F 414, a microphone 415, a speaker 416, an audio input and output I/F 417, a display 418, an external apparatus connection I/F 419, a near field communication circuit 420, an antenna 420a for the near field communication circuit 420, a touch panel 421, and a data bus 410.

The telecommunication circuit 412 is a circuit that communicates with another device or apparatus via the communication network 100. The CMOS sensor 413 is a built-in imaging device that captures the image of a subject under the control of the CPU 401 to obtain image data. The imaging element I/F 414 is a circuit that controls the driving of the CMOS sensor 413. The microphone 415 is a built-in circuit that converts sound into electrical signals. The speaker 416 is a built-in circuit that converts electrical signals into physical vibration to produce sounds such music and voice. The audio input and output I/F 417 is a circuit that processes input of audio signals from the microphone 415 and output of audio signals to the speaker 416 under the control of the CPU 401. The display 418 is a display device implemented as a liquid crystal or organic electroluminescence (EL) display, for example, which displays the image of the subject and various icons, for example. The external apparatus connection I/F 419 is an interface for connecting the smartphone 4 to various external apparatuses. The near field communication circuit 420 is a communication circuit conforming to a standard such as near field communication (NFC) or Bluetooth (registered trademark). The touch panel 421 is an input device for the user to operate the smartphone 4 by pressing the display 418. The data bus 410 includes an address bus and a data bus for electrically connecting the CPU 401 and the other components in FIG. 4 to each other.

A hardware configuration of the spherical imaging device 6 will be described.

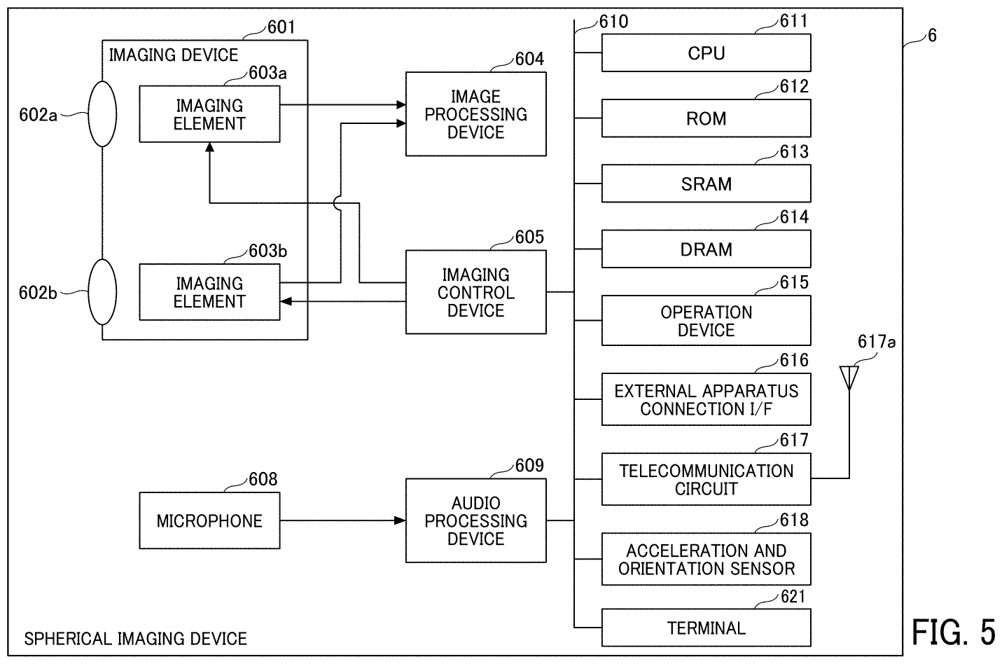

FIG. 5 is a block diagram illustrating an example of the hardware configuration of the spherical imaging device 6. In the following description, the spherical imaging device 6 is an all-directional spherical imaging device including two imaging elements. The spherical imaging device 6, however, may include two or more imaging elements. Further, the spherical imaging device 6 is not necessarily required to be dedicated to the purpose of capturing the all-directional image. Therefore, an all-directional imaging device may be additionally attached to a regular digital camera or smartphone, for example, to provide substantially the same function as that of the spherical imaging device 6.

As illustrated in FIG. 5, the spherical imaging device 6 includes an imaging device 601, an image processing device 604, an imaging control device 605, a microphone 608, an audio processing device 609, a CPU 611, a ROM 612, a static RAM (SRAM) 613, a dynamic RAM (DRAM) 614, an operation device 615, an external apparatus connection I/F 616, a telecommunication circuit 617, an antenna 617a, an acceleration and orientation sensor 618, and a terminal 621. The acceleration and orientation sensor 618 includes an electronic compass, a gyro sensor, and an acceleration sensor, for example. The terminal 621 is a recessed terminal for a micro USB cable.

The imaging device 601 includes two fisheye (i.e., wide-angle) lenses 602a and 602b and two imaging elements 603a and 603b corresponding thereto. Each of the fisheye lenses 602a and 602b has an angle of view of at least 180 degrees to form a hemispherical image. Each of the imaging elements 603a and 603b includes an image sensor, a timing signal generating circuit, and a group of registers, for example. The image sensor may be a CMOS or CCD sensor that converts an optical image formed by the fisheye lens 602a or 602b into image data in the form of electrical signals and outputs the image data. The timing signal generating circuit generates signals such as a pixel clock signal and a horizontal or vertical synchronization signal for the image sensor. Various commands and parameters for the operation of the imaging element 603a or 603b are set in the group of registers.

Each of the imaging elements 603a and 603b of the imaging device 601 is connected to the image processing device 604 via a parallel I/F bus, and is connected to the imaging control device 605 via a serial I/F bus (e.g., an inter-integrated circuit (I2C) bus). The image processing device 604, the imaging control device 605, and the audio processing device 609 are connected to the CPU 611 via a bus 610. The bus 610 is further connected to the ROM 612, the SRAM 613, the DRAM 614, the operation device 615, the external apparatus connection I/F 616, the telecommunication circuit 617, and the acceleration and orientation sensor 618, for example.

The image processing device 604 receives image data items from the imaging elements 603a and 603b via the parallel I/F bus, performs a predetermined process on the image data items, and combines the processed image data items to generate the data of an equirectangular projection image.

The imaging control device 605 sets commands in the groups of registers of the imaging elements 603a and 603b via the serial I/F bus such as the I2C bus, with the imaging control device 605 and the imaging elements 603a and 603b normally acting as a master device and slave devices, respectively. The imaging control device 605 receives the commands from the CPU 611. The imaging control device 605 further receives data such as status data from the groups of registers in the imaging elements 603a and 603b via the serial I/F bus such as the I2C bus, and transmits the received data to the CPU 611.

The imaging control device 605 further instructs the imaging elements 603a and 603b to output the image data when a shutter button of the operation device 615 is pressed. The spherical imaging device 6 may have a preview display function or a video display function using a display (e.g., the display 418 of the smartphone 4). In this case, the imaging elements 603a and 603b continuously output the image data at a predetermined frame rate. The frame rate is defined as the number of frames per minute.

The imaging control device 605 also functions as a synchronization controller that cooperates with the CPU 611 to synchronize the image data output time between the imaging elements 603a and 603b. In the embodiment, the spherical imaging device 6 is not equipped with a display. The spherical imaging device 6, however, may be equipped with a display.

The microphone 608 converts sound into audio (signal) data. The audio processing device 609 receives the audio data from the microphone 608 via an I/F bus, and performs a predetermined process on the audio data.

The CPU 611 controls the overall operation of the spherical imaging device 6, and executes various processes. The ROM 612 stores various programs for the CPU 611. The SRAM 613 and the DRAM 614, which are used as work memories, store programs executed by the CPU 611 and data being processed. The DRAM 614 particularly stores image data being processed in the image processing device 604 and processed data of the equirectangular projection image.

The operation device 615 collectively refers to operation buttons including a shutter button. The user operates the operation device 615 to input various image capture modes and image capture conditions, for example.

The external apparatus connection I/F 616 is an interface for connecting the spherical imaging device 6 to various external apparatuses. The external apparatuses in this case include a USB memory and a PC, for example. Via the external apparatus connection I/F 616, the data of the equirectangular projection image stored in the DRAM 614 may be recorded on an external recording medium, or may be transmitted as necessary to an external terminal (apparatus) such as the smartphone 4.

The telecommunication circuit 617 communicates with the external terminal (apparatus) such as the smartphone 4 via the antenna 617a of the spherical imaging device 6 in accordance with a near field wireless communication technology conforming to a standard such as wireless fidelity (Wi-Fi, registered trademark), NFC, or Bluetooth. The data of the equirectangular projection image may also be transmitted to the external terminal (apparatus) such as the smartphone 4 via the telecommunication circuit 617.

The acceleration and orientation sensor 618 calculates the orientation of the spherical imaging device 6 from the geomagnetism, and outputs orientation information. The orientation information is an example of related information (i.e., metadata) conforming to the exchangeable image file format (Exif) standard. The orientation information is used in image processing such as image correction of the captured image. The related information includes data such as the date and time of capturing the image and the data volume of the image data. The acceleration and orientation sensor 618 also detects changes in angles (i.e., the roll angle, the pitch angle, and the yaw angle) of the spherical imaging device 6 accompanying the movement of the spherical imaging device 6. The changes in the angles are an example of the related information (i.e., metadata) conforming to the Exif standard, and are used in image processing such as image correction of the captured image. The acceleration and orientation sensor 618 further detects the respective accelerations in three axial directions. The spherical imaging device 6 calculates the attitude thereof (i.e., the angle of the spherical imaging device 6 relative to the gravitational direction) based on the accelerations detected by the acceleration and orientation sensor 618. Equipped with the acceleration and orientation sensor 618, the spherical imaging device 6 is improved in the accuracy of image correction.

A description will be given of a functional configuration of the information processing system 1 (i.e., the lecture support system in the present example).

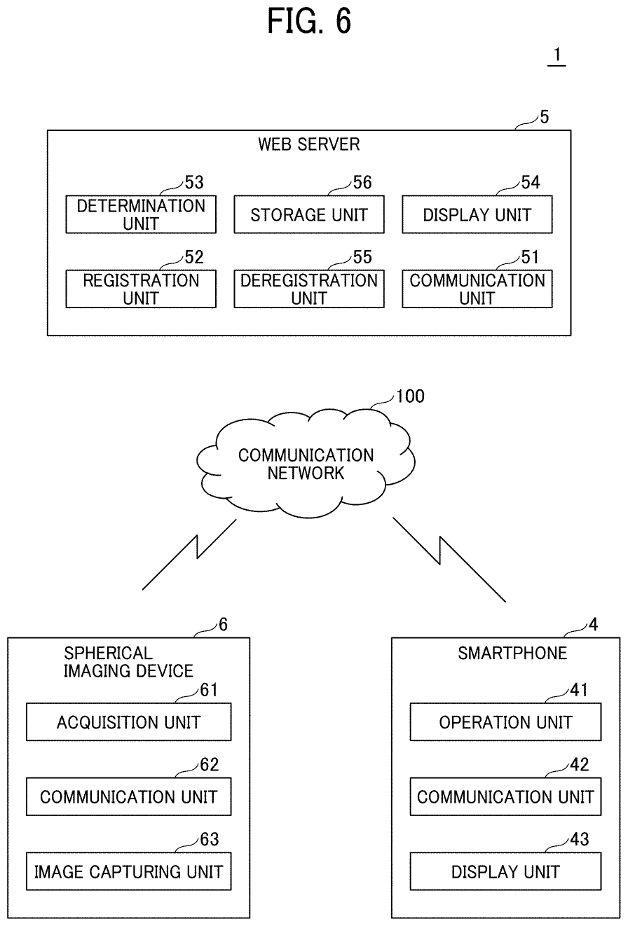

FIG. 6 is a block diagram illustrating an example of the functional configuration of the information processing system 1. As illustrated in FIG. 6, in the information processing system 1, the web server 5 includes a communication unit 51, a registration unit 52, a determination unit 53, a display unit 54, a deregistration unit 55, and a storage unit 56.

The function of the communication unit 51 is implemented by the network I/F 509 in FIG. 3, for example. The function of the storage unit 56 is implemented by the HD 504 in FIG. 3, for example. The functions of the registration unit 52, the determination unit 53, the display unit 54, and the deregistration unit 55 are implemented by a particular program executed by the CPU 501 in FIG. 3, for example.

The communication unit 51 transmits and receives signals and data to and from the smartphone 4 or the spherical imaging device 6. Specifically, when starting the lecture, the instructor 20 operates the smartphone 4 to issue an image capturing start instruction to start the image capturing of the spherical imaging device 6. Then, the communication unit 51 receives the image capturing start instruction (i.e., an image capturing start instruction signal) from the smartphone 4. In response to receipt of the image capturing start instruction signal from the smartphone 4, the communication unit 51 transmits the image capturing start instruction signal to the spherical imaging device 6.

Further, when ending the lecture, the instructor 20 operates the smartphone 4 to issue an image capturing end instruction to end the image capturing of the spherical imaging device 6. Then, the communication unit 51 receives the image capturing end instruction (i.e., an image capturing end instruction signal) from the smartphone 4. In response to receipt of the image capturing end instruction signal from the smartphone 4, the communication unit 51 transmits the image capturing end instruction signal to the spherical imaging device 6.

Further, in response to receipt of a request for lecture information from the smartphone 4, the communication unit 51 transmits to the smartphone 4 particular lecture information corresponding to the request. The communication unit 51 is also capable of transmitting and receiving various signals and data other than the above-described ones.

In response to receipt of an instruction signal from the smartphone 4, the registration unit 52 registers the spherical imaging device 6 as the terminal to be controlled in the target lecture. Specifically, in response to receipt of a connection request from the spherical imaging device 6 via the communication unit 51, the registration unit 52 registers the spherical imaging device 6 as the terminal to be controlled in response to receipt of the instruction signal from the smartphone 4.

The determination unit 53 determines whether the image capturing of the spherical imaging device 6 is executable based on status information representing the status of the spherical imaging device 6. The status information includes at least the battery capacity, the storage capacity, and the thermal state of the spherical imaging device 6. As well as these information items, any other information item representing the status of the spherical imaging device 6 may also be used as the status information.

For example, if the battery capacity of the spherical imaging device 6 is equal to or higher than a threshold value (e.g., 50%) in the status information of the spherical imaging device 6 received via the communication unit 51, the determination unit 53 determines the image capturing as executable. Further, if the battery capacity of the spherical imaging device 6 is lower than a threshold value (e.g., 50%), the determination unit 53 determines the image capturing as inexecutable. Whether the image capturing is executable is also determined based on a threshold value similarly set for each of the storage capacity and the thermal state. The threshold value may be set as appropriate by the user of the smartphone 4, for example. The determination may be made based on one, a plurality, or all of the information items of the status information.

The display unit 54 displays the status information of the spherical imaging device 6. If the determination unit 53 determines that the image capturing of the spherical imaging device 6 is inexecutable, the display unit 54 displays a message notifying that the image capturing is inexecutable.

The image capturing start instruction signal (i.e., the image capturing start instruction) and the image capturing end instruction signal (i.e., the image capturing end instruction) may be transmitted based on a user operation performed on the display unit 54.

The deregistration unit 55 deregisters the spherical imaging device 6 registered by the registration unit 52. Specifically, the deregistration unit 55 transmits the image capturing end instruction signal (i.e., the image capturing end instruction) to the spherical imaging device 6 via the communication unit 51 to deregister the spherical imaging device 6 after the image capturing of the spherical imaging device 6 is ended.

The deregistration unit 55 may also deregister the spherical imaging device 6 when the determination unit 53 determines that the image capturing of the spherical imaging device 6 is inexecutable.

The lecture information and the information received from the spherical imaging device 6 are stored in the storage unit 56 via the communication unit 51. Details of the information stored in the storage unit 56 will be described later.

The smartphone 4 includes an operation unit 41, a communication unit 42, and a display unit 43. The function of the operation unit 41 is implemented by the touch panel 421 in FIG. 4, for example. The function of the communication unit 42 is implemented by the telecommunication circuit 412 or the near field communication circuit 420 in FIG. 4, for example. The function of the display unit 43 is implemented by the display 418 in FIG. 4, for example.

The smartphone 4 is previously installed with application software for supporting lecture delivery (hereinafter referred to as the lecture support application). Before starting the lecture, the instructor 20 starts the lecture support application via the operation unit 41 to issue the image capturing start instruction to start the image capturing of the spherical imaging device 6. In response to receipt of the image capturing start instruction, the communication unit 42 transmits the image capturing start instruction signal to the web server 5.

The operation unit 41 receives various operations performed on the smartphone 4 and a variety of application software installed on the smartphone 4.

The communication unit 42 transmits and receives signals and data to and from the web server 5. The communication unit 42 further acquires the connection information from the web server 5. The connection information of the embodiment includes the IP address of the web server 5 and identification information for identifying the lecture delivered by the instructor 20 using the smartphone 4. In the following description, the identification information for identifying the lecture may be described as the lecture ID.

The display unit 43 displays a screen for receiving a registration start operation to start the registration of the spherical imaging device 6 associated with the lecture ID and a registration end operation to end the registration of the spherical imaging device 6 associated with the lecture ID. The display unit 43 further displays, on the screen of the display 418 of the smartphone 4, the status information of the spherical imaging devices 6 registered in the registration unit 52 of the web server 5 and transmitted from the web server 5.

Thereby, the instructor 20 is able to check the status of each spherical imaging device 6.

The spherical imaging device 6 includes an acquisition unit 61, a communication unit 62, and an image capturing unit 63. The functions of the acquisition unit 61 and the communication unit 62 are implemented by the telecommunication circuit 617 in FIG. 5, for example. The function of the image capturing unit 63 is implemented by the imaging device 601 in FIG. 5, for example.

When starting the image capturing, the spherical imaging device 6 receives the image capturing start instruction signal from the web server 5 via the communication unit 62, and starts the image capturing in response to the image capturing start instruction signal. The spherical imaging device 6 further transmits the captured image (e.g., video image) to the web server 5 via the communication unit 62. When ending the image capturing, the spherical imaging device 6 receives the image capturing end instruction signal from the web server 5, and ends the image capturing in response to the image capturing end instruction signal.

The acquisition unit 61 acquires the connection information for connecting to the web server 5. The connection information is acquired through reading a two-dimensional bar code, such as quick response (QR) code (registered trademark), for example, displayed on the display unit 54 of the web server 5 or the display unit 43 of the smartphone 4 or through near field wireless communication conforming to a standard such as Bluetooth. The information acquired by the acquisition unit 61 is not limited to the connection information, and also includes the smartphone ID and the lecture ID, for example.

The communication unit 62 transmits and receives signals and data to and from the web server 5. That is, the communication unit 62 communicates with the web server 5 based on the connection information acquired by the acquisition unit 61. The spherical imaging device 6 is capable of transmitting the terminal number thereof to the web server 5 via the communication unit 62 to register the spherical imaging device 6 (i.e., the information processing terminal) in the web server 5.

The image capturing unit 63 captures the 360-degree, all-directional image in response to receipt of the image capturing start instruction signal from the web server 5. The image captured by the image capturing unit 63 is transmitted to the web server 5 via the communication unit 62.

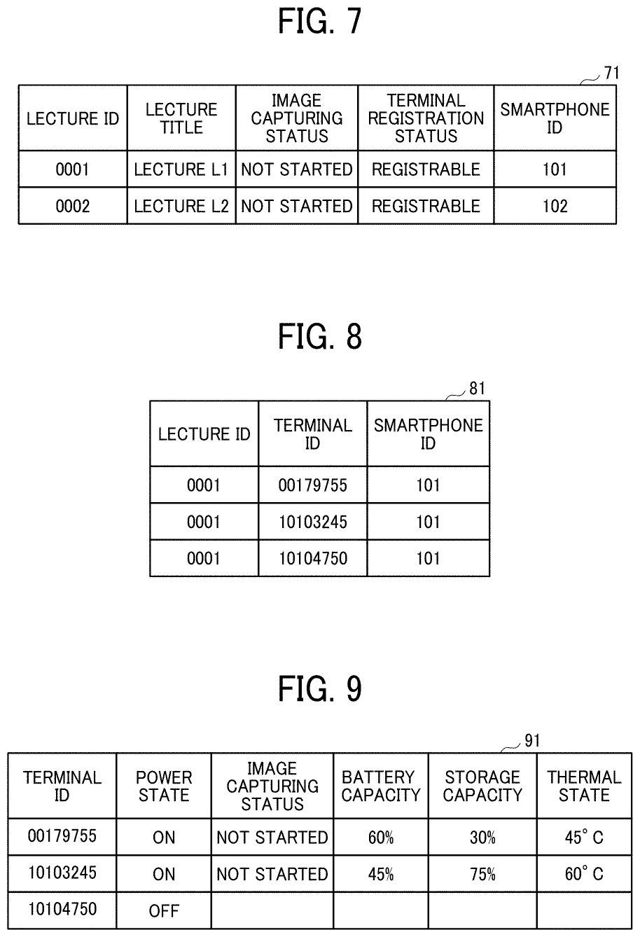

The information stored in the storage unit 56 of the web server 5 will be described with FIGS. 7 to 9.

FIG. 7 is a table illustrating an example of the lecture information of the embodiment. A table 71 illustrated in FIG. 7 stores information items “lecture ID,” “lecture title,” “image capturing status,” “terminal registration status,” and “smartphone ID.” The table 71 of the embodiment may be previously registered in the web server 5, for example.

The lecture ID is information unique to each lecture to identify the lecture. The lecture title represents the title of the lecture corresponding to the lecture ID. The lecture ID may be associated with the identification information of the smartphone 4 used by the instructor 20 who delivers the lecture identified by the lecture ID, for example.

The image capturing status represents the image capturing status in the lecture, and may be information described as “not started,” “in progress,” or “complete,” for example. In the example illustrated in FIG. 7, the image capturing status is “not started.”

The terminal registration status indicates whether the spherical imaging device 6 is registrable in the registration unit 52. The terminal registration status may be information described as “registrable” or “unregistrable,” for example. If the terminal registration status is “registrable,” the spherical imaging device 6 is registrable in the registration unit 52. If the terminal registration status is “unregistrable,” the spherical imaging device 6 is not registrable in the registration unit 52. The terminal registration status changes depending on the status of communication between the smartphone 4 and the web server 5.

The terminal registration status is “registrable” during the time from the receipt by the web server 5 of a request from the smartphone 4 to start the registration of the spherical imaging device 6 to the receipt by the web server 5 of a request from the smartphone 4 to end the registration of the spherical imaging device 6.

The terminal registration status is “unregistrable” when the web server 5 has not received the request from the smartphone 4 to start the registration of the spherical imaging device 6.

FIG. 8 is a table illustrating an example of the registration status of the spherical imaging device 6 of the embodiment. A table 81 illustrated in FIG. 8 is generated when the spherical imaging device 6 is registered in the web server 5. In the table 81, the lecture ID, the smartphone ID, and the terminal ID are stored in association with each other. The lecture ID may be previously associated with the smartphone ID in the table 71. The smartphone ID is an ID unique to each smartphone 4, and the terminal ID is an ID unique to each spherical imaging device 6.

FIG. 9 is a table illustrating an example of the status information of the spherical imaging device 6 of the embodiment. A table 91 illustrated in FIG. 9 stores the information acquired from the spherical imaging device 6. In the table 91, information of the power state, the image capturing status, the battery capacity, the storage capacity, and the thermal state is stored for each terminal ID. The power state is information indicating whether the power supply of the spherical imaging device 6 is on or off. The image capturing status is information indicating whether the image capturing of the spherical imaging device 6 is in progress, completed, or yet to be started. The battery capacity is information representing the remaining battery capacity of the spherical imaging device 6. The storage capacity is information representing the free space on the storage area of the spherical imaging device 6. The thermal state is information representing the temperature of the spherical imaging device 6.

It suffices if the status information represents the status of the spherical imaging device 6, and thus the status information is not limited to the above-described examples.

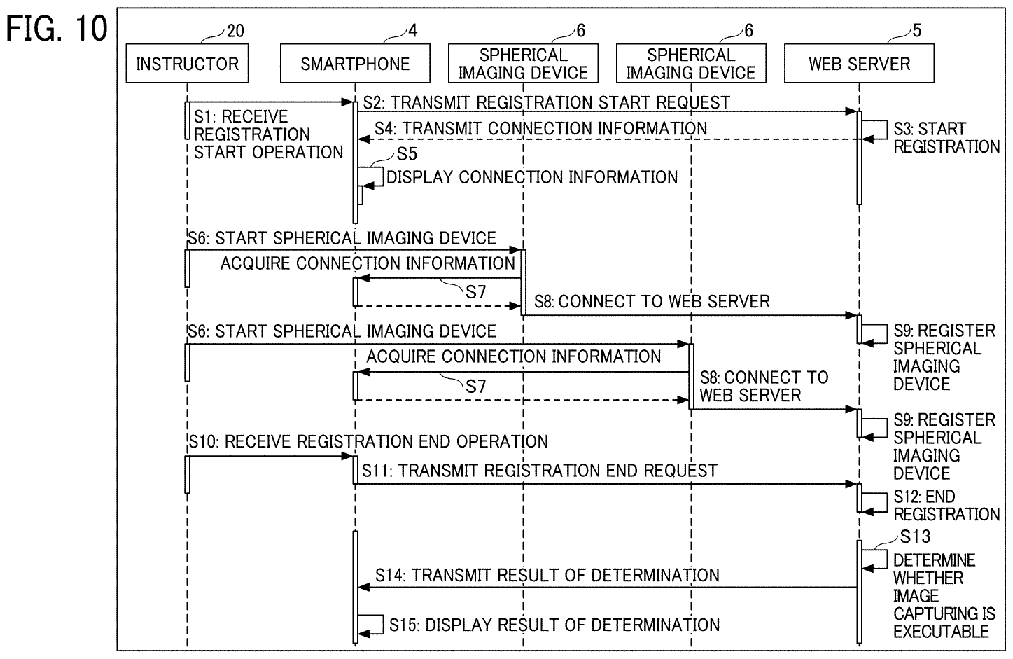

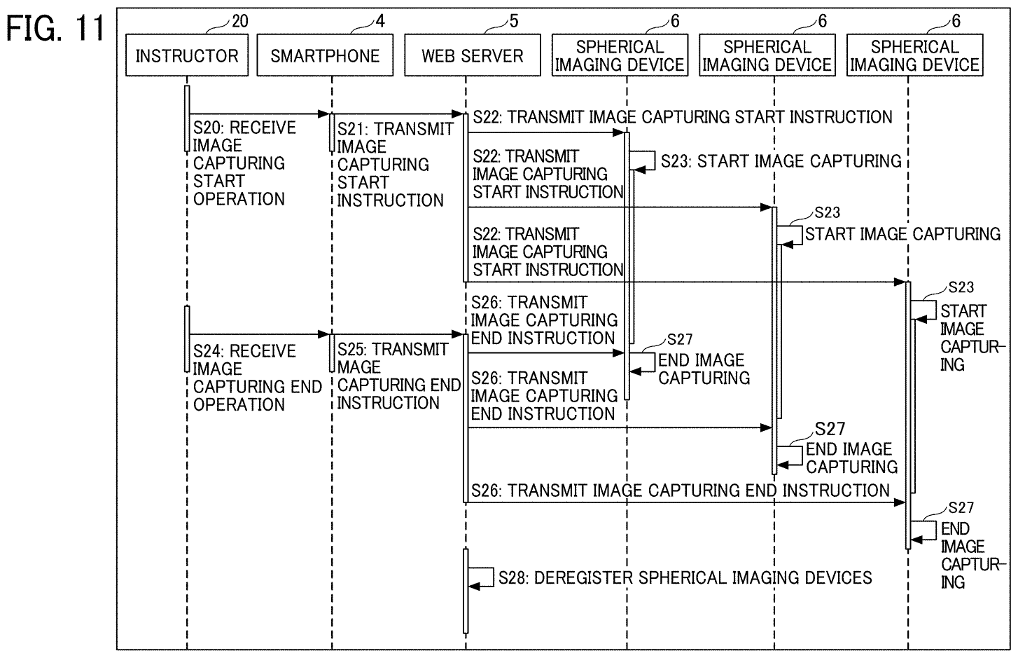

An operation of the information processing system 1 will be described with FIGS. 10 and 11.

FIG. 10 is a sequence diagram illustrating a registration process of the spherical imaging device 6 of the embodiment.

At step S1, the smartphone 4 first receives a registration start operation performed by the instructor 20 to start the registration of each spherical imaging device 6. The registration start operation is executable with the lecture support application installed on the smartphone 4.

At step S2, in response to receipt of the registration start operation, the smartphone 4 transmits a registration start request to the web server 5 to start the registration of the spherical imaging device 6. The registration start request includes the smartphone ID of the smartphone 4, for example.

At step S3, in response to receipt of the registration start request to start the registration of the spherical imaging device 6, the web server 5 starts to accept the registration of the spherical imaging device 6. Specifically, the web server 5 refers to the table 71 (see FIG. 7) and changes the terminal registration status corresponding to the acquired smartphone ID to “registrable” from “unregistrable.” With this process, the web server 5 allows the connection from the spherical imaging device 6.

At step S4, the web server 5 transmits to the smartphone 4 the connection information for the connection to the web server 5. Herein, the connection information includes the IP address of the web server 5 and lecture ID of the lecture to be registered.

At step S5, the smartphone 4 displays information including the connection information received from the web server 5 and the smartphone ID on the display 418 of the smartphone 4. That is, the smartphone 4 displays the information including the connection information on the display 418. The information including the connection information is displayed in the form of a two-dimensional bar code (e.g., QR code), for example.

At step S6, the instructor 20 starts the spherical imaging device 6 through the operation of the smartphone 4. In this step, the instructor 20 may start a particular spherical imaging device 6 desired to be remote-controlled.

At step S7, the spherical imaging device 6 reads the connection information and the smartphone ID displayed on the display 418 of the smartphone 4. Specifically, the two-dimensional bar code displayed on the display 418 of the smartphone 4 may be placed over the spherical imaging device 6 so that the spherical imaging device 6 reads the connection information and the smartphone ID.

At step S8, the spherical imaging device 6 connects to the web server 5 with the acquired connection information. That is, the spherical imaging device 6 transmits a connection request to the web server 5. The connection request includes the terminal ID of the spherical imaging device 6, the lecture ID of the lecture to be registered, and the smartphone ID acquired at step S7.

At step S9, the web server 5 registers the spherical imaging device 6, which has connected to the web server 5. Specifically, in response to receipt of the connection request from the spherical imaging device 6, the registration unit 52 of the web server 5 refers to the table 71 and identifies the smartphone ID and the lecture ID included in the connection request. The registration unit 52 then generates the table 81, in which the smartphone ID, the terminal ID, and the lecture ID included in the connection request are associated with each other.

In the embodiment, with the generation of the table 81 in the web server 5, the association between the smartphone 4, the spherical imaging device 6, and the lecture is completed. That is, the registration of the spherical imaging device 6 in the web server 5 is completed.

In the embodiment, the terminal ID is thus associated with the lecture ID, enabling the spherical imaging device 6 to be registered for each lecture.

According to the embodiment, the spherical imaging device 6 is registered in the web server 5, enabling the remote control of the spherical imaging device 6 with the smartphone 4 via the web server 5. That is, according to the embodiment, the registration unit 52 registers the spherical imaging device 6 connected to the web server 5 as the spherical imaging device 6, the image capturing unit 63 of which is allowed to be controlled.

The processes of steps S6 to S9 are performed for each spherical imaging device 6 desired to be registered.

At step S10, the smartphone 4 receives a registration end operation performed by the instructor 20 to end the registration of the spherical imaging device 6. The registration end operation is executable with the lecture support application installed on the smartphone 4.

At step S11, in response to receipt of the registration end operation, the smartphone 4 transmits a registration end request to the web server 5 to end the registration of the spherical imaging device 6.

At step S12, in response to receipt of the registration end request to end the registration of the spherical imaging device 6, the web server 5 ends the registration of the spherical imaging device 6.

At step S13, based on the status information of the spherical imaging device 6, the web server 5 determines whether the image capturing of the registered spherical imaging device 6 is executable.

At step S14, the web server 5 transmits the result of the determination to the smartphone 4. If it is determined that the image capturing of the registered spherical imaging device 6 is inexecutable, the display 418 of the smartphone 4 displays a message notifying that the image capturing is inexecutable.

In the example illustrated in FIG. 10, the smartphone 4 is used to perform the registration start operation, the registration end operation, the display of the connection information, and the display of the message notifying that the image capturing is inexecutable. Alternatively, these operations may be performed with the web server 5, without the smartphone 4. That is, a single information processing apparatus may serve both as the smartphone 4 and the web server 5.

In the embodiment, the smartphone 4 acquires the connection information for the connection to the web server 5, as described above, thereby allowing a desired number of spherical imaging devices 6 to be registered in the web server 5 until the registration end operation is performed.

According to the embodiment, therefore, the number of spherical imaging devices 6 to be remote-controlled is dynamically changeable. Further, in the embodiment, the spherical imaging device 6 is made remote-controllable simply by causing the spherical imaging device 6 to read the two-dimensional bar code displayed on the display 418 of the smartphone 4, for example. According to the embodiment, therefore, a desired number of spherical imaging devices 6 are made remote-controllable with a simple operation, with no need for a procedure of previously registering the information of the spherical imaging devices 6 in the web server 5.

In the embodiment, the spherical imaging device 6 connects to the web server 5 to register the spherical imaging device 6 in the web server 5. Alternatively, the smartphone 4 may connect to the web server 5 to register the spherical imaging device 6 in the web server 5. Specifically, the smartphone 4 may read a two-dimensional bar code attached to a casing of the spherical imaging device 6 and containing information such as the terminal ID. Then, the smartphone 4 may transmit the lecture ID, the smartphone ID, and the terminal ID to the web server 5 when connecting to the web server 5, to thereby register the spherical imaging device 6 in the web server 5.

FIG. 11 is a sequence diagram illustrating an image capturing process of the spherical imaging device 6 of the embodiment.

At step S20, the smartphone 4 first receives an image capturing start operation performed by the instructor 20 to start the image capturing of each spherical imaging device 6. The image capturing start operation is executable with the lecture support application installed on the smartphone 4.

At step S21, in response to receipt of the image capturing start operation, the smartphone 4 transmits the image capturing start instruction signal to the web server 5.

At step S22, in response to receipt of the image capturing start instruction signal, the web server 5 transmits the image capturing start instruction signal to the spherical imaging device 6.

At step S23, in response to receipt of the image capturing start instruction signal, the spherical imaging device 6 starts the image capturing.

At step S24, the smartphone 4 receives an image capturing end operation performed by the instructor 20 to end the image capturing of the spherical imaging device 6. The image capturing end operation is executable with the lecture support application installed on the smartphone 4.

At step S25, in response to receipt of the image capturing end operation, the smartphone 4 transmits the image capturing end instruction signal to the web server 5.

At step S26, in response to receipt of the image capturing end instruction signal, the web server 5 transmits the image capturing end instruction signal to the spherical imaging device 6.

At step S27, in response to receipt of the image capturing end instruction signal, the spherical imaging device 6 ends the image capturing.

At step S28, after the image capturing process is ended in all spherical imaging devices 6, the deregistration unit 55 of the web server 5 deregisters the registered spherical imaging devices 6.

Specifically, the deregistration unit 55 deletes the table 81 associating the smartphone ID of the smartphone 4 with the terminal IDs of the spherical imaging devices 6, thereby terminating the association between the smartphone 4 and the spherical imaging devices 6.

The deregistration process is thus performed after the image capturing is ended, thereby making the spherical imaging devices 6 manageable for each lecture. The deregistration process of step S28 may be omitted.

In the example illustrated in FIG. 11, the smartphone 4 is used to perform the image capturing start operation and the image capturing end operation. Alternatively, these operations may be performed with the web server 5, without the smartphone 4. That is, the web server 5 may implement the functions of the smartphone 4.

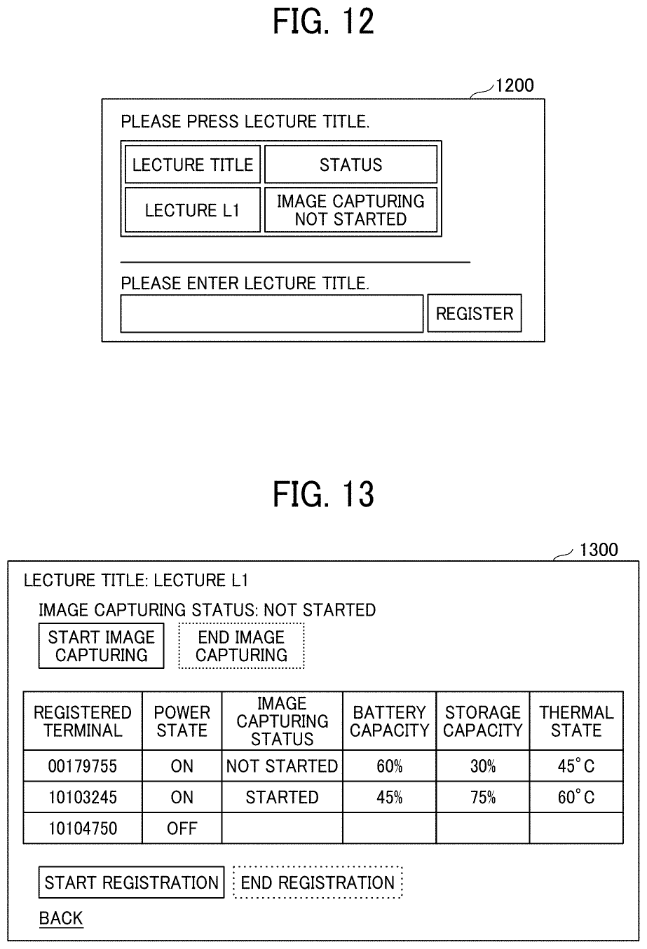

FIGS. 12 and 13 are diagrams illustrating examples of a display screen displayed by the display unit 43 of the smartphone 4.

FIG. 12 is a diagram illustrating an example of the screen displayed on the smartphone 4 of the embodiment. The lecture is registrable on a screen 1200 illustrated in FIG. 12. The instructor 20 enters the lecture title in a corresponding field on the screen 1200 to register the lecture, for which the information processing system 1 is going to be used.

If the instructor 20 presses the lecture title displayed on the screen 1200, the screen 1200 transitions to another example of the screen, which will be described below.

FIG. 13 is a diagram illustrating another example of the screen displayed on the smartphone 4 of the embodiment. The operation of instructing to start the image capturing, the operation of instructing to end the image capturing, the operation of instructing to start the registration, and the operation of instructing to end the registration are executable on a screen 1300 illustrated in FIG. 13. The instructor 20 presses a “START IMAGE CAPTURING” button to instruct to start the image capturing with the information processing system 1, and presses an “END IMAGE CAPTURING” button to instruct to end the image capturing with the information processing system 1.

Further, the instructor 20 presses a “START REGISTRATION” button to instruct to start the registration of the spherical imaging device 6 (i.e., a registration start instruction), and presses an “END REGISTRATION” button to instruct to end the registration of the spherical imaging device 6 (i.e., a registration end instruction).

In the embodiment, a new spherical imaging device 6 is registrable in response to receipt of the operation of pressing the “START REGISTRATION” button even after the “START IMAGE CAPTURING” button is pressed, i.e., even during the image capturing. Thereby, the number of registered spherical imaging devices 6 is easily changeable.

Further, with the screen 1300, the instructor 20 is able to check the status information of each registered spherical imaging device 6 (i.e., information processing terminal). The instructor 20 is therefore able to identify any spherical imaging device 6 having an issue or not performing the image capturing.

As described above, at least one of the embodiments facilitates managing, for each event, the information processing terminal to be remote-controlled.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

In the above-described embodiment, the information processing system 1 includes the web server 5, the smartphone 4, and the spherical imaging device 6, for example. The web server 5 and the smartphone 4, however, may be integrated together instead of being provided separately.

In the above-described embodiment, the web server 5 includes the registration unit 52, the determination unit 53, the deregistration unit 55, and the storage unit 56, for example. These units, however, may be included in the smartphone 4. Further, in the above-described embodiment, the smartphone 4 includes the operation unit 41. The operation unit 41, however, may be included in the web server 5.

In the above-described embodiment, the spherical imaging device 6 includes the acquisition unit 61 and the image capturing unit 63, for example. The acquisition unit 61 and the image capturing unit 63, however, may be included in the smartphone 4.

In the above-described embodiment, the system for supporting lecture delivery has been presented as an example of the information processing system 1. What is supported by the information processing system 1, however, is not limited to the lecture delivery. The information processing system 1 of the embodiment is also applicable to a variety of seminars or product information sessions and a variety of events including various presentations.

The ordinal numbers and quantities used in the above description are illustrative for the purpose of specifically describing the technique of the present invention, and do not limit the present invention. Further, the connective relations between the components in the above description are similarly illustrative for the purpose of specifically describing the technique of the present invention, and do not limit the connective relations for implementing the functions of present invention.

Further, the division of blocks in the functional block diagram is illustrative. In the above-described blocks, therefore, a plurality of blocks may be implemented as a single block, or a single block may be divided into a plurality of blocks. Further, the function of one of the above-described blocks may be included in another one of the blocks. Further, similar functions of two or more of the blocks may be processed in parallel or in a time-sharing manner by a single hardware or software component.

Each of the functions of the described embodiments may be implemented by one or more processing circuits or circuitry. Circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions. Further, the above-described steps are not limited to the order disclosed herein.

1. An information processing apparatus comprising:
a memory configured to store event identification information identifying an event; and
first circuitry configured to register terminal identification information in association with the event identification information stored in the memory,
the terminal identification information identifying an information processing terminal to be used in the event, and being received during a time from receipt of a registration start instruction to start registration of the information processing terminal to receipt of a registration end instruction to end the registration of the information processing terminal.

2. An information processing system comprising:
the information processing apparatus of claim 1; and
an information processing terminal including second circuitry,
the second circuitry of the information processing terminal being configured to
acquire connection information for connecting to the information processing apparatus, and
transmit terminal identification information identifying the information processing terminal to the information processing apparatus based on the acquired connection information.

3. An information processing system comprising:
the information processing apparatus of claim 1;
an information processing terminal; and
a communication terminal including third circuitry,
the third circuitry of the communication terminal being configured to
acquire terminal identification information identifying the information processing terminal,
transmit the acquired terminal identification information to the information processing apparatus, and
causing a display to display a screen to receive a registration start instruction to start registration of the terminal identification information and a registration end instruction to end the registration of the terminal identification information, and
the information processing apparatus receiving the terminal identification information from the communication terminal.

4. The information processing system of claim 3, wherein the third circuitry of the communication terminal transmits communication terminal identification information identifying the communication terminal to the information processing apparatus, and
wherein the first circuitry of the information processing apparatus registers the communication terminal identification information in association with the event identification information and the terminal identification information.

5. The information processing system of claim 3, wherein, based on status information of the information processing terminal, the first circuitry of the information processing apparatus determines to generate a determination result that image capturing by the information processing terminal is inexecutable, and
wherein, in response to receipt of the determination result that the image capturing by the information processing terminal is inexecutable, the third circuitry of the communication terminal causes the display to display information notifying that the image capturing by the information processing terminal is inexecutable.

6. The information processing system of claim 5, wherein the status information includes at least one of battery capacity, storage capacity, and thermal state of the information processing terminal.

7. The information processing system of claim 3, wherein in response to receipt of an image capturing end instruction to end image capturing of the information processing terminal, the first circuitry of the information processing apparatus terminates the association between the terminal identification information of the information processing terminal corresponding to the image capturing end instruction and the event identification information.

8. An information processing method comprising:
with an information processing apparatus, storing event identification information identifying an event in a memory; and
with the information processing apparatus, registering terminal identification information in association with the event identification information stored in the memory, the terminal identification information identifying an information processing terminal to be used in the event, and being received during a time from receipt of a registration start instruction to start registration of the information processing terminal to receipt of a registration end instruction to end the registration of the information processing terminal.

9. The information processing method of claim 8, further comprising:
with a communication terminal communicable with the information processing apparatus and the information processing terminal, acquiring the terminal identification information identifying the information processing terminal;
with the communication terminal, transmitting the acquired terminal identification information to the information processing apparatus; and
with the communication terminal, causing a display to display a screen to receive a registration start instruction to start registration of the terminal identification information and a registration end instruction to end the registration of the terminal identification information.

10. A non-transitory recording medium storing a plurality of instructions which, when executed by one or more processors, cause the processors to perform an information processing method comprising:
with an information processing apparatus, storing event identification information identifying an event in a memory; and
with the information processing apparatus, registering terminal identification information in association with the event identification information stored in the memory, the terminal identification information identifying an information processing terminal to be used in the event, and being received during a time from receipt of a registration start instruction to start registration of the information processing terminal to receipt of a registration end instruction to end the registration of the information processing terminal.

11. The non-transitory recording medium of claim 10, wherein the information processing method further comprises:
with a communication terminal communicable with the information processing apparatus and the information processing terminal, acquiring the terminal identification information identifying the information processing terminal;
with the communication terminal, transmitting the acquired terminal identification information to the information processing apparatus; and
with the communication terminal, causing a display to display a screen to receive a registration start instruction to start registration of the terminal identification information and a registration end instruction to end the registration of the terminal identification information.
